(19) United States
(12) Patent Application Publication
(10) Pub. No.: US 2003/0070514 A1
(43) Pub. Date: Apr. 17, 2003

(54) TEAR DROP HAND GRIP FOR TORQUE APPLYING TOOLS

(76) Inventor: Gary H. Kilgore, San Antonio, TX (US)

Correspondence Address: Gary Kilgore, 239 Calumet Place, San Antonio, TX, 78209, US

(21) Appl. No.: 09/981,381

(22) Filed: Oct. 16, 2001

(51) Int. Cl. B25G 1/01

(52) U.S. Cl. 81/489

(57) ABSTRACT

A tear drop hand grip to manipulate torque applying tools includes a primary gripping portion and a secondary portion at the base for stabilizing the orientation of a torque applying tool. Both lay symmetrically along the longitudinal axis of a torque applying tool. The primary portion is hemispherical at its' first end where it is joined to the torque applying tool and tapers to a dimension approximating one half the diameter of the hemisphere at the second end. The surface of the primary portion may include projections configured to enhance friction between the primary gripping portion and a hand gripping same. The secondary portion is attached to the second end of the primary portion and may rotate unconstrained by the rotation of the primary portion.

### CROSS-REFERENCES TO RELATED APPLICATIONS

| | | |
|---|---|---|
| 687,401 | Morse | Nov. 26, 1901 |
| 3,742,787 | Whiteford | Jul. 3, 1973 |
| 4,093,008 | Martin | Jun. 6, 1978 |
| D 273,268 | Smith | Apr. 3, 1984 |
| 4,488,460 | Ballone | Dec. 18, 1984 |
| D 329,367 | Landy | Sep. 15, 1992 |
| D 368,213 | Marks | Mar. 26, 1996 |
| D 373,944 | Thompson | Sep. 24, 1996 |
| 6,189,423 B1 | Kaminski | Feb. 20, 2001 |

### BACKGROUND OF INVENTION

1. Field of Invention

The novelty disclosed in this document pertains to hand tools. More narrowly, it applies to hand grips for torque applying tools, such as, screwdrivers.

Hand grips for applying torque typically have a generally cylindrical shape about the axis of rotation with a series of surface protrusions to provide resistance to finger travel about the surface of the hand grip. The base of the hand grip is usually smooth to allow a user to rotate the tool with fingertips by manipulating the surface protrusions, while the base is planted in the user's palm to maintain the orientation of the tool. This common configuration is a compromise between economy and stowage considerations, on the one hand, and ergonomics on the other.

While designs conforming to this general description are not functionally optimal, they are inexpensive to produce and demand minimal stowage space. Consequentially, the vast majority of screwdrivers and nut drivers take this basically cylindrical form.

Hand grips that conform to the natural grip of the human hand occupy a significantly smaller segment of the market. Ergonomic forms attempt to reflect the general dimensions of the cavity formed by a gently clasped hand. It is not unusual for them to curve along their length, which produces clearance issues for hand and hand grip in many areas of operation, and the obvious requirement of a ratcheting mechanism. A ratchet is certainly a good feature, but it significantly adds to the cost of a product. The market at large does not place a premium on ergonomic hand grips, which limit's the market to discriminating individuals willing to pay a premium for improved performance. Missing from the marketplace is a hand grip that has a superior ergonomic form that can be manipulated with one hand without the need of a ratchet.

2. Description of the Related Art Including Information Disclosed Under 37 CFR 1.97 and 1.98

In 1901, Morse was issued U.S. Pat. No. 687,401 for a screwdriver sporting a hand grip with a base that rotated free of the remainder of the hand grip. The improvement allowed the hand grip to be rotated with negligible friction between the base of the handle and a palm when the base was planted against a palm.

In 1973, Whiteford was issued U.S. Pat. No. 3,742,787 for a ratcheting hand tool with a spherical handle. Though this handle is symmetrical about the axis of rotation, it would perform poorly without the ratchet. Being spherical, the handle is drawn deep into a hand cavity when planting the base against a palm. Without the ratchet, it would be awkward to rotate the handle with one hand. However, this handle does incorporate a ratchet and it is sweet. It is, without a doubt, the most comfortable screwdriver 1 have ever used. Unfortunately, the handle and shaft readily disengage. Many a time, I have been high on a ladder when the handle popped off, fell to the floor, and bounced off to oblivion. But I've got to say, I've owned it 23 years and it hasn't broken yet.

In 1978, Martin was issued U.S. Pat. No. 4,093,008 for a screwdriver sporting a base that rotates free of the remainder of the handle, as in Morse's 1901 patent.

In 1984, Smith was issued design Pat. No. 273,268 which was assigned to Fiskars Corporation. Small resilient rectangular threads enhance this grip, which curiously, only a few competitors have imitated. This is an extremely comfortable handle and is still in production as of this writing in 2001.

In 1992, Landy was issued design Pat. No. 329,367. The geometry of this handle is similar to Smith's and quite comfortable.

In 1984, Ballone was issued U.S. Pat. No. 4,488,460 for a ratcheting nut driver with handle shaped like a large egg on an axis diagonal to the longitudinal axis of the driver. When I purchased mine, some ten years ago, it was available off of Mac Tool trucks. This tool is so comfortable and well built that I look for excuses to use it.

In 1996, Marks was issued design Pat. No. 368,213 for a ratcheting screwdriver with an essentially pistol grip shaped handle. This too, is an exceptionally comfortable handle.

In 1996, Thompson was issued design Pat. No. 373,944 for an essentially pistol grip shaped handle. This handle is available from Snap-On Technologies. I haven't used this tool, but it sure looks cool.

In 2001, Kaminski was issued U.S. Pat. No. 6,189,423 B1 for the most eccentric hand grip imaginable, and it almost defies description. It looks more like something you would find in a sushi bar than a tool box. Three large lobes extend along its' length, radiating outward to create a relatively large diameter at the work end of the handle and converging to a significantly reduced diameter at the base. It is an intriguing product. NASA should seriously consider procuring a quantity of these to scatter about in the path of visitors from rival space agencies. It would have an intimidating effect.

### OBJECTS AND ADVANTAGES

The objectives and advantages of the improvements disclosed in this document are, a hand grip: with a superior ergonomic form that distributes friction between the hand grip and hand widely across both surfaces, enhancing both leverage and comfort; which is symmetrical about the axis of rotation to avoid the necessity of a ratcheting mechanism; comfortably manipulated with one hand; and economical.

### REFERENCE NUMERALS IN DRAWINGS

1—hand grip

2—torque applying tool

4—axis of torque applying tool

10—primary mass

12—first end of primary mass

14—hemisphere

16—first pole

20—equator

22—imaginary sphere

24—first position

26—first imaginary line

28—second imaginary line

30—second end of primary mass

32—center of diameter of second end of primary mass

34—diameter of second end of primary mass

36—friction enhancing projections

40—secondary mass

42—first end of secondary mass

44—second end of secondary mass

### BRIEF DESCRIPTION OF THE SEVERAL VIEWS OF THE DRAWINGS

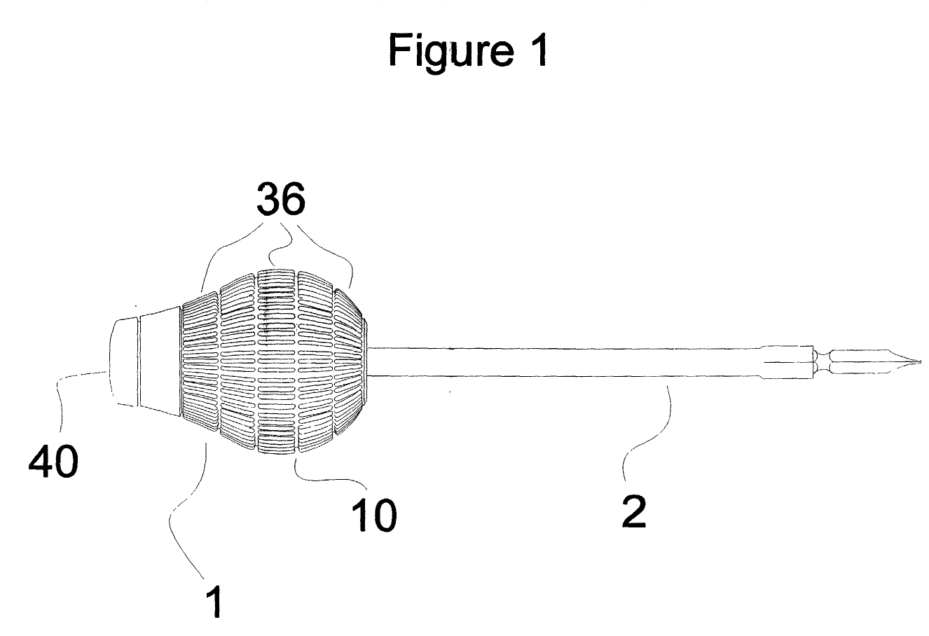

FIG. 1—Tear Drop Hand Grip 1 attached to torque applying tool 2, demonstrating the locations of: the Primary Mass 10, Secondary Mass 40; and the friction enhancing projections 36.

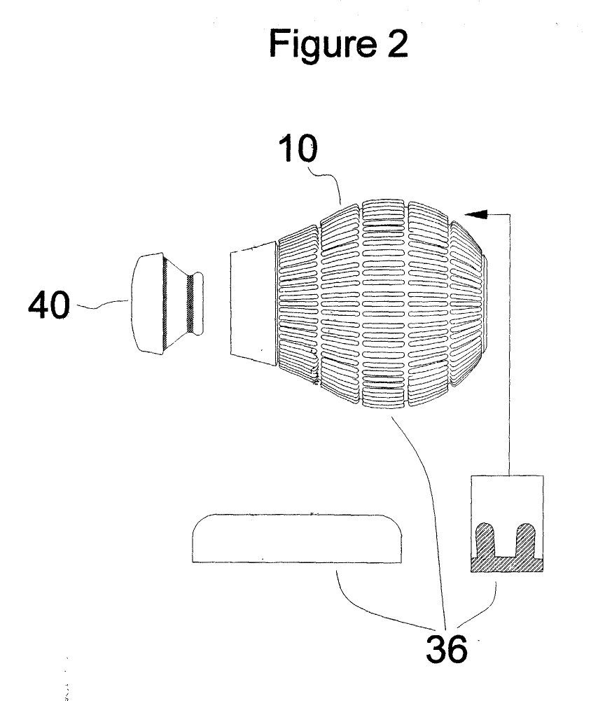

FIG. 2—Exploded Tear Drop Hand Grip 1 illustrating side views of: Primary Mass 10 and Secondary Mass 40, with magnified views of a friction enhancing projection 36.

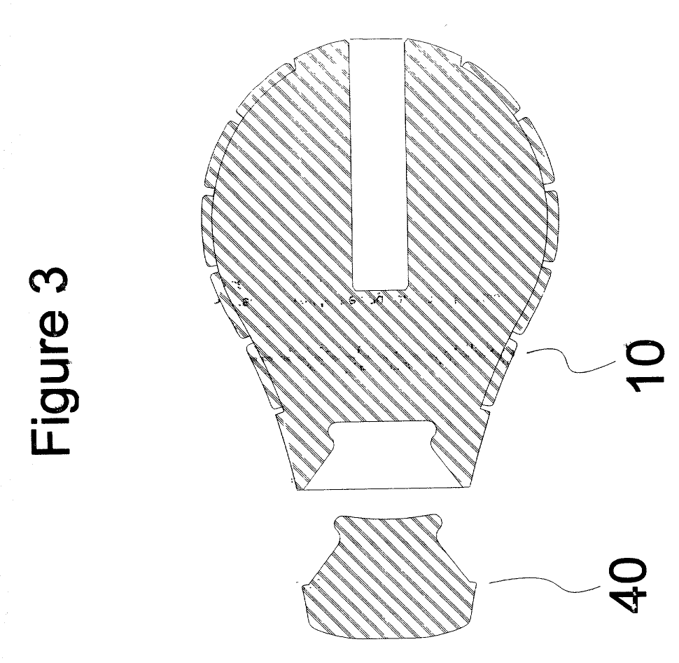

FIG. 3—Cross Section of a Primary Mass 10 and a Secondary Mass 40.

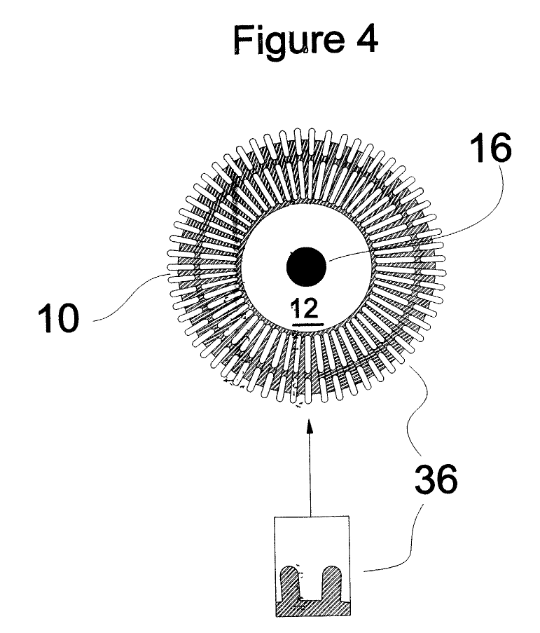

FIG. 4—First end View of Primary Mass 10 the relative positions of: first end of primary mass 12; first pole 16; and friction enhancing projections 36, with magnified view of a friction enhancing projection

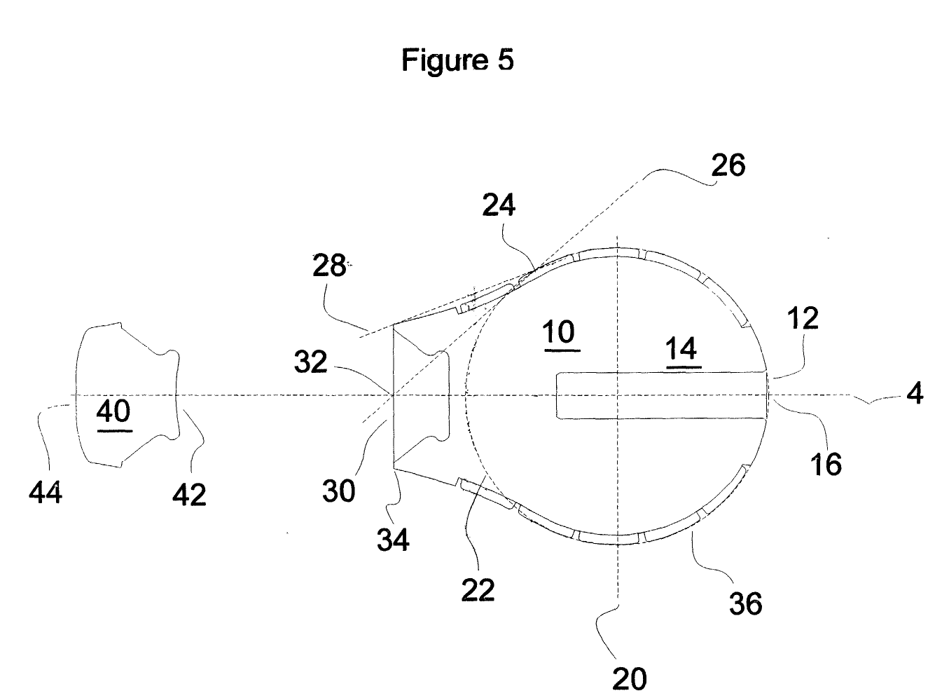

FIG. 5—Schematic of Primary Mass 10 and Secondary Mass 40 showing the relative positions of: axis of torque applying tool 4; first end of primary mass 12; hemisphere 14; first pole 16; equator 20; imaginary sphere 22; first position 24; first imaginary line 26; second imaginary line 28; second end of primary mass 30; center of diameter of second end of primary mass 32; diameter of second end of primary mass 34; friction enhancing projections 36; first end of secondary mass 42; and second end of secondary mass 44.

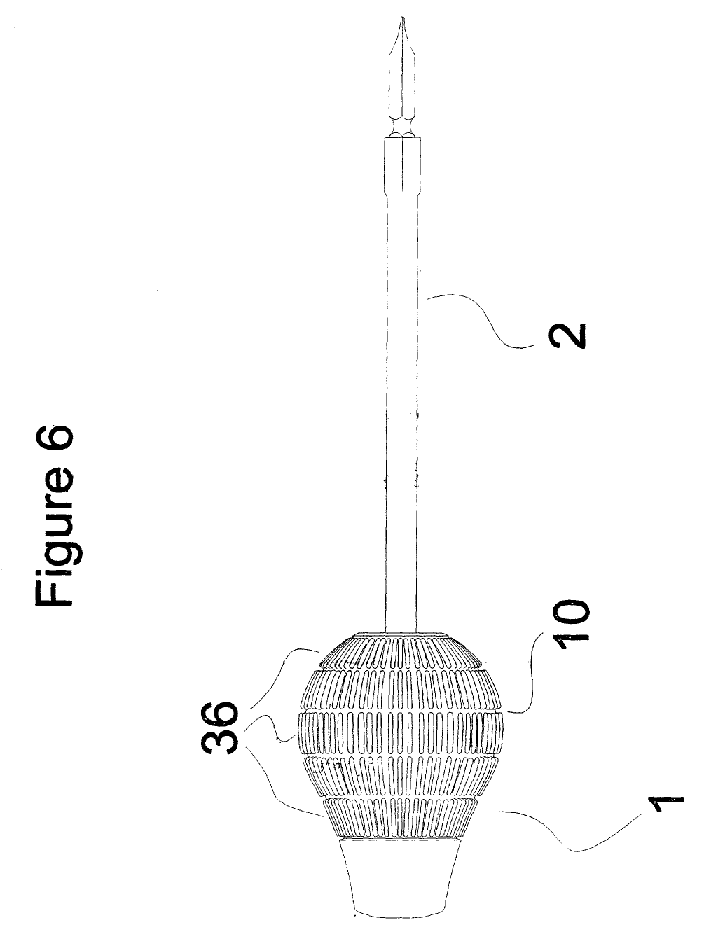

FIG. 6—Tear Drop Hand Grip 1 attached to torque applying tool 2 demonstrating the location of the friction enhancing projections 36. While FIGS. 1-5 illustrated an embodiment of the hand grip that integrates a primary mass and a secondary mass, this embodiment is confined to a single mass.

### DETAILED DESCRIPTION OF THE INVENTION

The tear drop hand grip 1 for torque applying tools 2 as illustrated according to the invention is shown to have a primary mass 10 and a secondary mass 40, both of which are symmetrical about the axis 4 of a torque applying tool 2. The primary mass 10 is shown to have a first end 12 and a second end 30, both of which lay on the axis 4 of a torque applying tool. The first end 12 of the primary mass 10 communicates with a torque applying tool 2. A first pole 16 of a hemisphere 14 is located at the first end 12, with the hemisphere 14 extending in the direction of the second end 30. An imaginary sphere 22 occupies the same location as the hemisphere 14 and has an equator 20. At the equator 20 the primary mass 10 begins to reduce in diameter symmetrical with the gradient of the hemisphere 14 until reaching a first position 24 that is determined by a first imaginary line 26 that is tangential to the diameter of the imaginary sphere 22 and passes through the center 32 of the diameter of the second end of the primary mass 30. From the first position 24 to the second end 30 of the primary mass 10, the primary mass 10 reduces in diameter relative to a second imaginary line 28 between the first position 24 and a diameter 34 of the second end 30 which approximates one half a dimension of the equator 20. The surface of the primary mass 10 is replete with friction enhancing projections 36. The first end 42 of the secondary mass 40 communicates with the second end 30 of the primary mass 10.

The tear drop hand grip for torque applying tools has been described in some detail by way of illustrations for purposes of clarity and understanding. It will, of course, be understood that various changes and modifications may be made in the form, details, and arrangements of the parts without departing from the scope of the invention as set forth in the claims.

### BRIEF SUMMARY OF THE INVENTION

The improvement disclosed in this document is an ergonomic hand grip configuration for manipulation of a torque applying tool. The handle projects from a shaft end of a torque applying tool, and extends symmetrically along the axis of the shaft. The handle has a shaft end and a palm end. The shaft end of the handle is hemispherical, with the diameter of the handle reducing by approximately one half the diameter of the hemisphere at the palm end. The surface of the handle, from the shaft end to the palm end is provided with a series of small treads. Extending from the palm end is a base that rotates independent from the handle.

This configuration offers superior surface contact between hand and handle, with the consequence that the torque load is distributed relatively evenly to muscles in the hand. This distribution of the load allows the hand to provide greater torque with less effort.

I claim:

1. A hand grip to manipulate torque applying tools, comprising: a mass having a first end and a second end which are centered on a longitudinal axis of a torque applying tool, and is symmetrical about the axis of the torque applying tool, the first end communicates with the tool, a hemisphere with a first pole originating at the first end extends in the direction of the second end, at an equator of an imaginary sphere which corresponds to the dimensions and positioning of the hemisphere, the mass begins reducing in diameter symmetrical with a gradient of the hemisphere until reaching a first position that is determined by a first imaginary line that is tangential to a diameter of the imaginary sphere and passes through a center of a diameter of the second end, from the first position to the second end, the mass reduces in diameter relative to a second imaginary line between the first position and a diameter of the second end which approximates a radius of the equator.

2. A hand grip to manipulate torque applying tools, comprising: a primary mass and a secondary mass, each of which have a first end and a second end which are centered on a longitudinal axis of a torque applying tool, and each of which is symmetrical about the axis of a torque applying tool, the first end of the primary mass communicates with the tool, a hemisphere with a first pole originating at the first end of the primary mass extends in the direction of the second end, at an equator of an imaginary sphere which corresponds to the dimensions and positioning of the hemisphere, the primary mass begins reducing in diameter symmetrical with a gradient of the hemisphere until reaching a first position that is determined by a first imaginary line that is tangential to a diameter of the imaginary sphere and passes through a center of a diameter of the second end of the primary mass, from the first position to the second end the primary mass reduces in diameter relative to a second imaginary line between the first position and a diameter of the second end which approximates a radius of the equator; the first end of the secondary mass communicates with the second end of the primary mass.

3. A hand grip in accordance with claim 2, including: a surface on a primary mass that is replete with tread like projections.
